(19) United States
(12) Patent Application Publication
(10) Pub. No.: US 2017/0261787 A1
(43) Pub. Date: Sep. 14, 2017

(54) LIQUID CRYSTAL DISPLAY AND MANUFACTURING METHOD THEREOF

(71) Applicant: Samsung Display Co., Ltd, Yongin-si (KR)

(72) Inventors: Chong Sup CHANG, Hwaseong-si (KR); Bum Soo KAM, Yongin-si (KR); Tae Wook KANG, Seongnam-si (KR); Hoon KANG, Suwon-si (KR)

(21) Appl. No.: 15/444,704

(22) Filed: Feb. 28, 2017

(30) Foreign Application Priority Data
Mar. 9, 2016 (KR) 10-2016-0028187

(51) Int. Cl. G02F 1/1341; G02F 1/1343; G02F 1/1337; G02F 1/1368; G02F 1/1333

(52) U.S. Cl. CPC G02F 1/1341; G02F 1/1368; G02F 1/133377; G02F 1/1337; G02F 1/13439; G02F 2201/123

(57) ABSTRACT

A liquid crystal display according to an exemplary embodiment includes: a substrate; a thin film transistor disposed on the substrate; a pixel electrode connected to the thin film transistor; a roof layer overlapping the pixel electrode; and a liquid crystal layer disposed in a plurality of microcavities between the pixel electrode and the roof layer. The roof layer includes two partitions disposed at respective sides of a microcavity selected from the plurality of microcavities and facing each other and a first inlet part and a second inlet part facing each other in a direction crossing a direction in which the two partitions face each other. A distance between the two partitions is shorter in the first inlet part than in a center part of the microcavity, and the distance between the two partitions is shorter in the second inlet part than in the center part of the microcavity.

### CROSS-REFERENCE TO RELATED APPLICATION

This application claims priority to and the benefit of Korean Patent Application No. 10-2016-0028187 filed in the Korean Intellectual Property Office on Mar. 9, 2016, the entire contents of which are incorporated herein by reference.

### BACKGROUND

(a) Technical Field

The present disclosure relates to a liquid crystal display and a manufacturing method thereof.

(b) Description of the Related Art

A liquid crystal display as one of flat panel display devices that are widely being used includes two display panels where field generating electrodes such as a pixel electrode and a common electrode are formed, and a liquid crystal layer is interposed therebetween. The liquid crystal display generates an electric field in the liquid crystal layer by applying a voltage to the field generating electrodes, to determine orientations of liquid crystal molecules of the liquid crystal layer and control polarization of incident light, thereby displaying an image.

In a nano crystal display (NCD) of the liquid crystal display, a sacrificial layer of an organic material is formed and a roof layer is formed thereon, and then the sacrificial layer is removed and the liquid crystal fills an empty space formed by the removal of the sacrificial layer, thereby making the display. By forming various constituent elements on one substrate, weight, thickness, and the like of the device may be reduced. However, when removing the sacrificial layer, a related failure due to a structure deformation of the roof layer may be generated.

The above information disclosed in this Background section is only for enhancement of understanding of the background and therefore it may contain information that does not form the prior art that is already known in this country to a person of ordinary skill in the art.

### SUMMARY

The present disclosure provides the liquid crystal display minimizing the structure deformation of the roof layer, and a manufacturing method thereof.

A liquid crystal display according to an exemplary embodiment of the present disclosure includes: a substrate; a thin film transistor disposed on the substrate; a pixel electrode connected to the thin film transistor; a roof layer overlapping the pixel electrode; and a liquid crystal layer disposed in a plurality of microcavities between the pixel electrode and the roof layer, wherein the roof layer includes two partitions disposed at respective sides of a microcavity selected from the plurality of microcavities and facing each other and a first inlet part and a second inlet part facing each other in a direction crossing a direction in which the two partitions face each other, a distance between the two partitions is shorter in the first inlet part than in a center part of the microcavity, and the distance between the two partitions is shorter in the second inlet part than in the center part of the microcavity.

The distance between the two partitions may be the same in the first inlet part and the second inlet part.

A height of the roof layer may be lower in the first inlet part than in the center part of the microcavity.

The height of the roof layer may be lower in the second inlet part than in the center part of the microcavity.

The height of the roof layer may be the same in the first inlet part and the second inlet part.

A cross-sectional shape of the first inlet part and the second inlet part may be a semi-elliptical shape.

The distance between the partitions may be gradually decreased from the center part of the microcavity toward the first inlet part and the second inlet part.

The distance between the two partitions in the first inlet part and the second inlet part may be 90% or less of the distance between the partitions in the center part of the microcavity.

The height of the roof layer may be gradually decreased from the center part of the microcavity toward the first inlet part and the second inlet part.

The height of the roof layer in the first inlet part and the second inlet part may be 90% or less of the height of the roof layer in the center part of the microcavity.

A manufacturing method of a liquid crystal display according to an exemplary embodiment of the present disclosure includes: forming a thin film transistor on a substrate including a first region and a second region crossing perpendicularly to each other; forming a pixel electrode on the thin film transistor; forming a plurality of sacrificial layers covering the pixel electrode and the first region and divided by the second region as a border; forming a roof layer on the plurality of sacrificial layers; removing the plurality of sacrificial layers to form a microcavity and a first inlet part and a second inlet part in the roof layer; forming an alignment layer at an inner wall of the microcavity; injecting a liquid crystal material into the microcavity; and forming a capping layer to cover the first inlet part and the second inlet part on the roof layer, wherein a width of the sacrificial layer is narrower in the first region than in a center part of the pixel electrode.

The width of the sacrificial layer may be gradually narrower from the center part of the pixel electrode toward the first region.

The sacrificial layer may have a height gradually lower from the center part of the pixel electrode toward the first region.

The sacrificial layer may have a cross-section of a semi-elliptical shape in the first region.

According to an exemplary embodiment of the present disclosure, the structure deformation of the roof layer is minimized such that defects related to a current leakage defect between the field generating electrodes, aligning agent aggregation, liquid crystal non-injection, the like may be minimized.

### BRIEF DESCRIPTION OF THE DRAWINGS

FIG. 1 is a schematic perspective view of a shape of a roof layer of a liquid crystal display according to an exemplary embodiment of the present disclosure.

FIG. 2 is a schematic top plan view of a liquid crystal display according to an exemplary embodiment of the present disclosure.

FIG. 3 is a top plan view of an enlarged part of a liquid crystal display according to an exemplary embodiment of the present disclosure.

FIG. 4 is a view showing one example of a cross-section taken along a line IV-IV of FIG. 3.

FIG. 5 is a view showing one example of a cross-section taken along a line V-V of FIG. 3.

FIG. 6 is a view showing one example of a cross-section taken along a line VI-VI of FIG. 3.

FIG. 7 is a view showing one example of a cross-section taken along a line V-V of FIG. 3.

FIG. 8 is a view showing one example of a cross-section taken along a line V-V of FIG. 3.

FIG. 9 and FIG. 10 are views schematically showing a sacrificial layer in a manufacturing method of a liquid crystal display according to an exemplary embodiment of the present disclosure.

### DETAILED DESCRIPTION OF THE EMBODIMENTS

The present disclosure will be described more fully hereinafter with reference to the accompanying drawings, in which exemplary embodiments are shown. As those skilled in the art would realize, the described embodiments may be modified in various different ways, all without departing from the spirit or scope of the present disclosure.

Parts that are irrelevant to the description will be omitted to clearly describe the present disclosure, and the same or similar constituent elements will be designated by the same reference numerals throughout the specification.

Further, in the drawings, size and thickness of each element are arbitrarily illustrated for ease of description, and the present disclosure is not necessarily limited to those illustrated in the drawings. In the drawings, the thickness of layers, films, panels, regions, etc., are exaggerated for clarity. In the drawings, for ease of description, the thicknesses of some layers and regions are exaggerated.

In addition, unless explicitly described to the contrary, the word “comprise” and variations such as “comprises” or “comprising” will be understood to imply the inclusion of stated elements but not the exclusion of any other elements. Also, in the entire specification, it will be understood that when an element such as a layer, film, region, or substrate is referred to as being “on” another element, it can be directly on the other element or intervening elements may also be present. Throughout this specification, it is understood that the term “on” and similar terms are used generally and are not necessarily related to a gravitational reference.

Further, in the specification, the phrase “in a plan view” means when an object portion is viewed from above, and the phrase “in a cross-section” means when a cross-section taken by vertically cutting an object portion is viewed from the side.

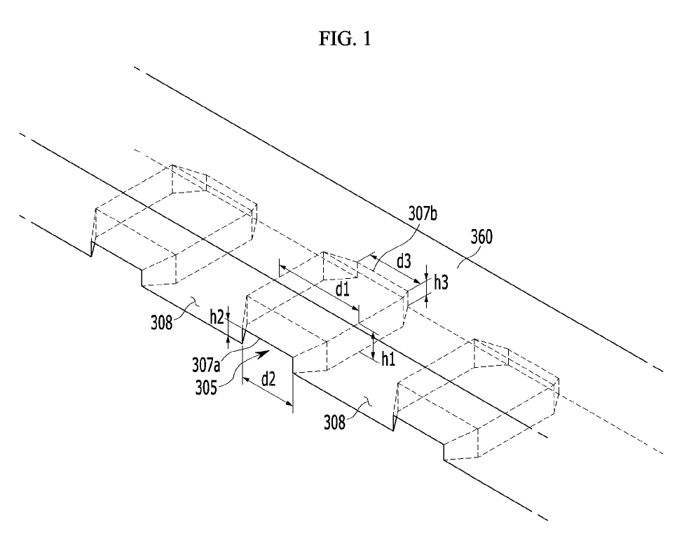

Now, a liquid crystal display according to an exemplary embodiment of the present disclosure will be described with reference to FIG. 1 while focusing on a shape of a roof layer 360. FIG. 1 is a schematic perspective view of a shape of the roof layer 360 of a liquid crystal display according to an exemplary embodiment of the present disclosure.

In the liquid crystal display, to form the liquid crystal display with one substrate, the roof layer 360 is a structure to form a plurality of microcavities 305. For convenience of description, a capping layer covering the roof layer 360 is not shown.

The roof layer 360 includes two partitions 308 at respective sides of the microcavity 305 that are drilled to inject a liquid crystal to be formed into a liquid crystal layer. The partition 308 as a part protruded from the roof layer 360 has a function of defining microcavities 305 adjacent to each other.

Also, the roof layer 360 includes a first inlet part 307a and a second inlet part 307b that are bored to inject the liquid crystal to the microcavity 305. The first inlet part 307a and the second inlet part 307b are disposed to face each other in a direction crossing a direction at which the adjacent partitions 308 face each other. The first inlet part 307a and the second inlet part 307b are covered by a capping layer described later.

The microcavity 305 is disposed between two partitions 308 facing each other in the roof layer 360, and a distance between the two facing partitions 308 becomes a width of the microcavity 305. The distance between the two partitions 308 facing each other has a difference depending on where the distance is measured at any position of the microcavity 305. In the present exemplary embodiment, a second distance d2 (also called the second width d2 of the microcavity 305) in the first inlet part 307a is shorter than a first distance d1 (also called the first width d1 of the microcavity 305) in the center part of the microcavity 305. Also, for the distance between two partitions 308 facing each other, a third distance d3 (also called a third width d2 of the microcavity 305) in the second inlet part 307b is shorter than the first distance d1 in the center part of the microcavity 305. For the distance between two partitions 308 facing each other, the second distance d2 in the first inlet part 307a and the third distance d3 in the second inlet part 307b may be equal to each other. In one embodiment, the distance d2, d3 between two partitions 308 facing each other in the first inlet part 307a and the second inlet part 307b is 90% or less of the distance d1 between the partitions 308 in the center part of the microcavity 305.

When the distance from the bottom of the microcavity 305 to a position where the microcavity 305 extends vertically and firstly meets the roof layer 360 is referred to as a height of the roof layer 360, for the height of the roof layer 360, a second height h2 (also called a second height h2 of the microcavity 305) in the first inlet part 307a is lower than a first height h1 (also called a first height h1 of the microcavity 305) in the center part of the microcavity 305. Also, for the height of the roof layer 360, a third height h3 (also called a third height h3 of the microcavity 305) in the second inlet part 307b is lower than the first height h1 in the center part of the microcavity 305. For the height of the roof layer 360, the third height h3 in the second inlet part 307b and the second height h2 in the first inlet part 307a may be the same. In one embodiment, the height h2, h3 of the roof layer 360 in the first inlet part 307a and the second inlet part 307b is 90% or less of the height h1 of the roof layer 360 in the center part of the microcavity 305.

Like the present exemplary embodiment, when the distance d2, d3 between the partitions 308 is shorter in the inlet parts 307a and 307b than the distance d1 at the center part of the microcavity 305 and the height h2, h3 of the roof layer 360 is lower in the inlet parts 307a and 307b than the height h1 at the center part of the microcavity 305, structural stability of the roof layer 360 is improved. In inlet part 307a and 307b, since the width d2, d3 and the height h2, h3 of the roof layer 360 are reduced, deflection of the roof layer 360 may be minimized, thereby preventing a current leakage defect due to the structure deformation of the field generating electrode formed on one surface of the roof layer 360.

An alignment material and the liquid crystal material including liquid crystal molecules may be injected into the microcavity 305 by capillary force, and in this case, the capillary force has a structurally stronger action in a narrow space. Accordingly, by controlling the width d2, d3 and the height h2, h3 of the roof layer 360 in the inlet part 307a and 307b, the part where the capillary force has stronger action may be controlled. That is, by controlling the capillary force near the inlet part 307a and 307b rather than in the center part of the microcavity 305 to not have a position where solids are agglomerated when injecting the alignment material, the liquid crystal material is uniformly injected such that the injection performance of the alignment material and the liquid crystal material may be improved.

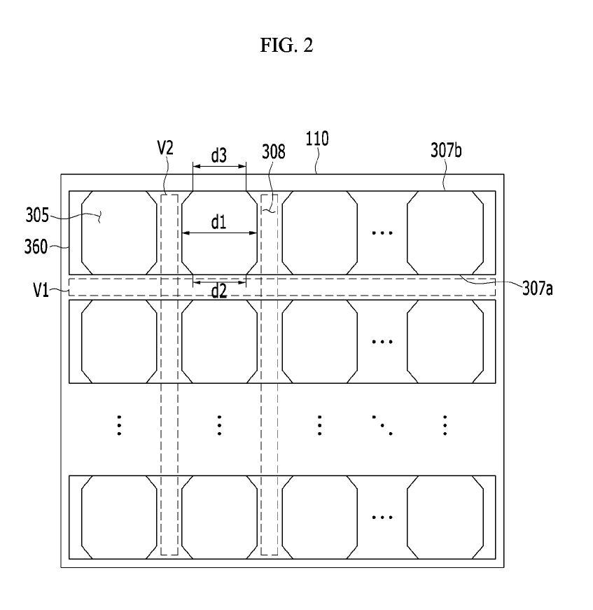

Next, the liquid crystal display according to an exemplary embodiment of the present disclosure will be described with reference to FIG. 2 to FIG. 6.

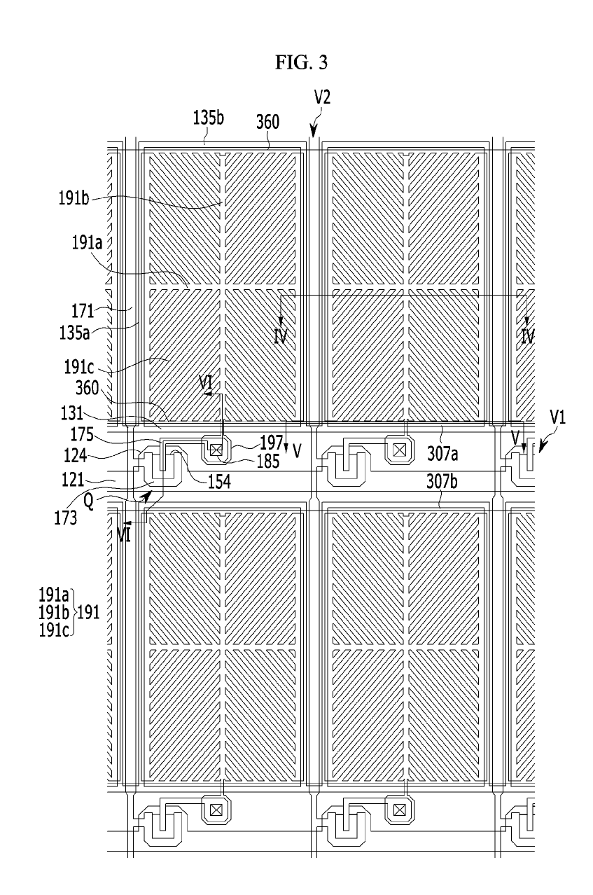

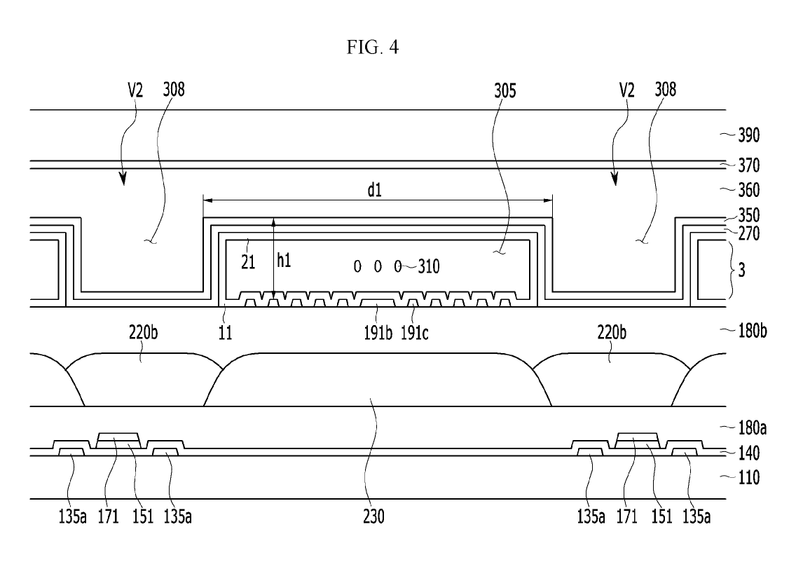

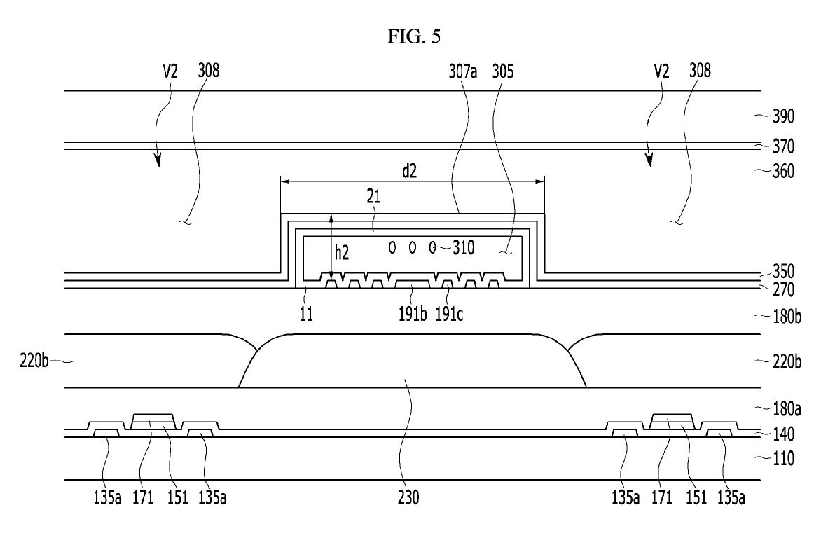

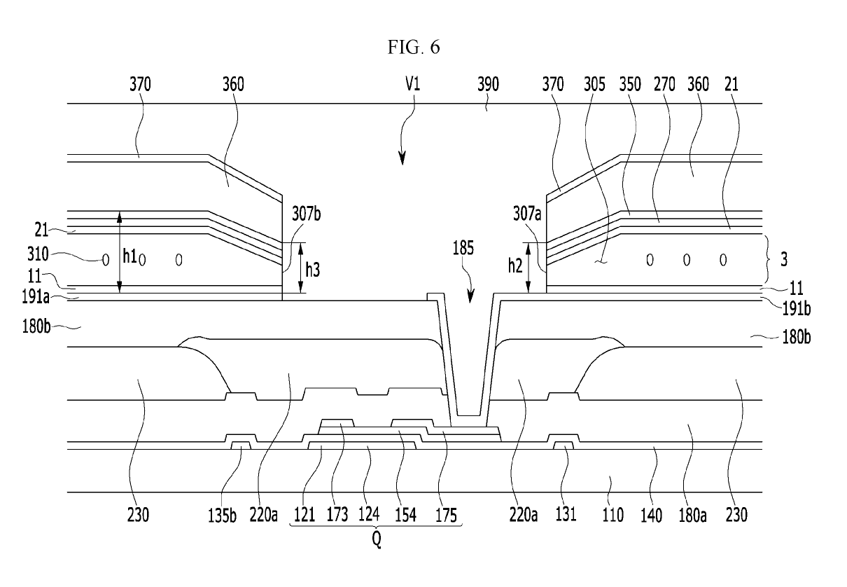

FIG. 2 is a schematic top plan view of a liquid crystal display according to an exemplary embodiment of the present disclosure, and FIG. 3 is a top plan view of an enlarged part of a liquid crystal display according to an exemplary embodiment of the present disclosure. FIG. 4 is a view showing one example of a cross-section taken along a line IV-IV of FIG. 3, FIG. 5 is a view showing one example of a cross-section taken along a line V-V of FIG. 3, and FIG. 6 is a view showing one example of a cross-section taken along a line VI-VI of FIG. 3.

Referring to FIG. 2, in the liquid crystal display according to the present exemplary embodiment, a plurality of microcavities 305 are disposed between a substrate 110 and the roof layer 360. FIG. 2 schematically shows a part where the plurality of microcavities 305 are formed. In the manufacturing process, the microcavity 305 that was the empty space is injected with the alignment material and the liquid crystal material to form an alignment layer and the liquid crystal layer.

The roof layer 360 may be divided in a first region V1 covered by the capping layer that is described later. In other words, the roof layer 360 may not exist in the first region V1.

In the roof layer 360, the first inlet part 307a and the second inlet part 307b are formed near a boundary of the first region V1 and the microcavity 305. The first inlet part 307a and the second inlet part 307b function as an inlet of the microcavity 305 to inject the alignment material and the liquid crystal material into the microcavity 305 before the first region V1 is covered by the capping layer. The first inlet part 307a and the second inlet part 307b may be covered to be sealed by the capping layer in the completed liquid crystal display.

The roof layer 360 may have a structure that extends in the horizontal direction, and includes a plurality of partitions 308 disposed at the second region V2 extending in a direction crossing the first region V1. The partitions 308 have a function of dividing the microcavities 305 adjacent to each other with respect to the second region V2. The partition 308 may be a part where the roof layer 360 is protruded in the direction toward the substrate 110. In other words, the partition 308 may be formed of the same material as the roof layer 360 and may be formed as one body. However, the partition 308 is not limited to this configuration, and the roof layer 360 may be separately formed.

The distance d2 between the partitions 308 adjacent to each other in the first inlet part 307a of the microcavity 305 is shorter than the distance d1 between the partitions 308 in the center part of the microcavity 305. The distance d3 between the partitions 308 in the second inlet part 307b of the microcavity 305 is shorter than the distance d1 between the partitions 308 in the center part of the microcavity 305. The distance d2 between the partitions 308 adjacent to each other in the first inlet part 307a of the microcavity 305 and the distance d3 between the partitions 308 in the second inlet part 307b may be the same.

The structure of the liquid crystal display according to an exemplary embodiment of the present disclosure is only an example, and numerous variations are possible. For example, the arrangement shape of the microcavity 305, the first region V1, and the second region V2 may be changed, and the plurality of roof layers 360 may be connected to each other in the first region V1.

A stacked structure of the liquid crystal display according to an exemplary embodiment of the present disclosure will be described with reference to FIG. 3 to FIG. 6. FIG. 3 is an enlarged view of four adjacent pixels among a plurality of pixels disposed in a matrix shape of FIG. 2.

The liquid crystal display according to an exemplary embodiment of the present disclosure includes a substrate 110 made of a material such as glass or plastic. The substrate 110 may be a flexible substrate.

A gate line 121 and a storage electrode line 131 are disposed on the substrate 110. The gate line 121 mainly extends in a horizontal direction and transfers a gate signal. The gate line 121 includes a gate electrode 124 protruding from the gate line 121. Here, the protruding form of the gate electrode 124 may be modified.

The storage electrode line 131 mainly extends in a horizontal direction and transfers a predetermined voltage such as a common voltage Vcom. The storage electrode line 131 includes a pair of vertical portions 135a extending to be substantially perpendicular to the gate line 121, and, and a horizontal portion 135b connecting ends of the pair of vertical portions 135a. The vertical portions and the horizontal portion 135a and 135b of the storage electrode line 131 may substantially surround a pixel electrode 191 to be described below.

A gate insulating layer 140 is disposed on the gate line 121 and the storage electrode line 131. The gate insulating layer 140 may be made of an inorganic material such as a silicon nitride (SiNx) and a silicon oxide (SiOx).

A semiconductor stripe layer 151 and a semiconductor layer 154 overlapping the gate electrode 124 are disposed on the gate insulating layer 140. The semiconductor stripe layer 151 and the semiconductor layer 154 may be made of amorphous silicon, polycrystalline silicon, or a metal oxide.

A data line 171 is disposed on the semiconductor stripe layer 151, and a source electrode 173 and a drain electrode 175 are disposed on the semiconductor layer 154.

The data line 171 transfers a data signal and mainly extends in a vertical direction to cross the gate line 121 and the storage electrode line 131. The gate electrode 124, the source electrode 173, and the drain electrode 175 form one thin film transistor Q together with the semiconductor layer 154, and a channel of the thin film transistor Q is formed in the semiconductor layer 154 overlapping the gate electrode 124 between the source electrode 173 and the drain electrode 175.

A first interlayer insulating layer 180a is disposed on the gate insulating layer 140 to cover the data line 171, the source electrode 173, the drain electrode 175, and the channel of the semiconductor layer 154. The first interlayer insulating layer 180a may be made of the inorganic material such as a silicon nitride (SiNx) and a silicon oxide (SiOx).

A color filter 230, a transverse light blocking member 220a, and a longitudinal light blocking member 220b are disposed on the first interlayer insulating layer 180a. The transverse light blocking member 220a is disposed in a direction parallel with the gate line 121, and the longitudinal light blocking member 220b is disposed in a direction parallel with the data line 171. The transverse light blocking member 220a and the vertical light blocking member 220b are connected to each other to have a lattice structure having an opening corresponding to an area displaying an image, and include a material which does not transmit light. Meanwhile, the horizontal light blocking member 220a and the vertical light blocking member 220b may be formed on an upper insulating layer 370 to be described below.

The color filter 230 is disposed in the opening by the transverse light blocking member 220a and the longitudinal light blocking member 220b, and may display one of primary colors such as three primary colors of red, green, and blue. However, the color filter 230 is not limited to the three primary colors of red, green, and blue, but may display one of cyan, magenta, yellow, and white-based colors. The color filter 230 may include a material displaying the same color for each pixel which is adjacent in a horizontal direction, and may include a material displaying different colors for each pixel which is adjacent in a vertical direction.

A second interlayer insulating layer 180b is disposed on the color filter 230, the transverse light blocking member 220a, and the vertical light blocking member 220b so as to cover the color filter 230, the horizontal light blocking member 220a, and the vertical light blocking member 220b. The second interlayer insulating layer 180b may include an inorganic material such as a silicon nitride (SiNx) and a silicon oxide (SiOx). Meanwhile, when a step is generated due to a difference in thickness between the color filter 230, the transverse light blocking member 220a, and the longitudinal light blocking member 220b, the second interlayer insulating layer 180b includes an organic material to reduce or remove the step.

The transverse light blocking member 220a and the first and second interlayer insulating layers 180a and 180b have a contact hole 185 extending to and overlapping a part of the drain electrode 175.

The pixel electrode 191 is disposed on the second interlayer insulating layer 180b. The pixel electrode 191 may be made of a transparent conductive material such as indium tin oxide (ITO) and indium zinc oxide (IZO). An overall shape of the pixel electrode 191 may be substantially a quadrangle. The pixel electrode 191 includes a cross stem configured by a horizontal stem 191a and a vertical stem 191b crossing the horizontal stem 191a. The pixel electrode 191 is divided into four domains by the horizontal stem 191a and the vertical stem 191b, and each domain includes a plurality of minute branches 191c.

The pixel electrode 191 includes an extension 197 which is connected at a lower end of the vertical stem 191b and has a larger area than the vertical stem 191b. The pixel electrode 191 is physically and electrically connected with the drain electrode 175 through the contact hole 185 at the extension 197 to receive a data voltage from the drain electrode 175.

The thin film transistor Q and the pixel electrode 191 described above are just described as examples, and a structure of the thin film transistor and a design of the pixel electrode may be modified in order to improve side visibility.

A common electrode 270 spaced apart from the pixel electrode 191 by a predetermined distance is disposed on the pixel electrode 191, and the microcavity 305 is disposed between the pixel electrode 191 and the common electrode 270. That is, the microcavity 305 is surrounded by the pixel electrode 191 and the common electrode 270. The common electrode 270 is disposed in a row direction, and may be formed on the microcavity 305 and may extend to also be formed in the second region V2. The common electrode 270 may be made of a transparent metal oxide such as indium-tin oxide (ITO), indium-zinc oxide (IZO), and the like. The common electrode 270 receives the common voltage and generates an electric field along with the pixel electrode 191 applied with the data voltage.

A lower alignment layer 11 and an upper alignment layer 21 are disposed on the pixel electrode 191 and below the common electrode 270, respectively. The lower alignment layer 11 and the upper alignment layer 21 face each other. The lower alignment layer 11 and the upper alignment layer 21 may be vertical alignment layers. The lower alignment layer 11 and the upper alignment layer 21 may include at least one of materials generally used as a liquid crystal alignment layer, such as polyamic acid, polysiloxane, or polyimide. The lower alignment layer 11 and the upper alignment layer 21 may be connected to each other on the side wall of the edge of the microcavity 305.

A lower insulating layer 350 is disposed on the common electrode 270. The lower insulating layer 350 may be formed of an inorganic material such as a silicon nitride (SiNx) or a silicon oxide (SiOx).

A roof layer 360 is disposed on the lower insulating layer 350. The roof layer 360 serves to divide the microcavity 305 which is a space between the pixel electrode 191 and the common electrode 270. The roof layer 360 may include a photoresist or other organic materials. Further, the roof layer 360 may be formed by a color filter.

The roof layer 360 has a first inlet part 307a and a second inlet part 307b to inject the liquid crystal material including liquid crystal molecules 310. A liquid crystal layer 3 made of the liquid crystal molecules 310 is disposed in the microcavity 305. The liquid crystal molecules 310 have negative dielectric anisotropy, and may stand up in a direction perpendicular to the substrate 110 while the electric field is not applied. That is, the liquid crystal molecules 310 may be vertically aligned. The liquid crystal material may be injected into the microcavity 305 through the first inlet part 307a or the second inlet part 307b by using capillary force. An alignment material forming the lower and upper alignment layers 11 and 21 may also be injected into the microcavity 305 through the first inlet part 307a or the second inlet part 307b before the liquid crystal material is injected. A width and an area of the microcavity 305 may be variously modified according to a size and a resolution of the display device. That is, the microcavity 305 may be formed in one pixel area, two adjacent pixel areas, or over the plurality of pixel areas.

The roof layer 360 includes a plurality of partitions 308 disposed between the plurality of microcavities 305 adjacent in the horizontal direction. The partitions 308 may be disposed along the direction that the data line 171 extends. A stress generated by the partition 308 is small even if the substrate 110 is bent, and a change degree of the cell gap may be substantially reduced. The partition 308 serves to support the shape of the microcavity 305.

The upper insulating layer 370 is provided on the roof layer 360. The upper insulating layer 370 may come into contact with an upper surface of the roof layer 360. The upper insulating layer 370 may be formed of the inorganic insulating material such as a silicon nitride (SiNx) or a silicon oxide (SiOx). The upper insulating layer 370 has a function of protecting the roof layer 360 made of the organic material, and if necessary, it may be omitted.

A capping layer 390 is disposed on the upper insulating layer 370. The capping layer 390 is also disposed in the first region V1 corresponding to the space between two microcavities 305 adjacent in the vertical direction, and covers the first inlet part 307a and the second inlet part 307b. That is, the capping layer 390 may seal the microcavity 305 so that the liquid crystal molecules 310 formed in the microcavity 305 are not discharged to the outside.

The capping layer 390 may be formed by coating a liquid capping layer formation material to be hardened. The capping layer 390 may include an organic material or an inorganic material. When the upper insulating layer 370 is not present, the capping layer 390 is disposed directly on the roof layer 360.

FIG. 4, taken along the line IV-IV of FIG. 3, shows the height of the roof layer 360 near the microcavity center part and the distance between the partitions 308, and FIG. 5, taken along the line V-V of FIG. 3, shows the height of the roof layer 360 and the distance between the partitions 308.

Comparing FIG. 4 and FIG. 5, for the distance between two partitions 308 facing each other via the microcavity 305 interposed therebetween, the distance d1 in the center part of the microcavity 305 is longer than the distance d2 in the first inlet part 307a. Although not shown separately from the cross-sectional view, as shown in FIG. 2, the distance d2 between two partitions 308 facing each other in the first inlet part 307a and the distance d3 between two partitions 308 facing each other in the second inlet part 307b may be the same.

When the distance from the bottom of the microcavity 305 to the position where the microcavity 305 extends vertically and firstly meets the roof layer 360 is referred to as the height of the roof layer 360, for the height of the roof layer 360, the second height h2 in the first inlet part 307a is lower than the first height h1 in the center part of the microcavity 305. Referring to FIG. 6, the height of the roof layer 360 may be formed to be decreased when the roof layer 360 is inclined from the center part of the microcavity 305 toward the inlet parts 307a and 307b, and the height h2 of the roof layer in the first inlet part 307a and the height h3 of the roof layer in the second inlet part 307b may be the same.

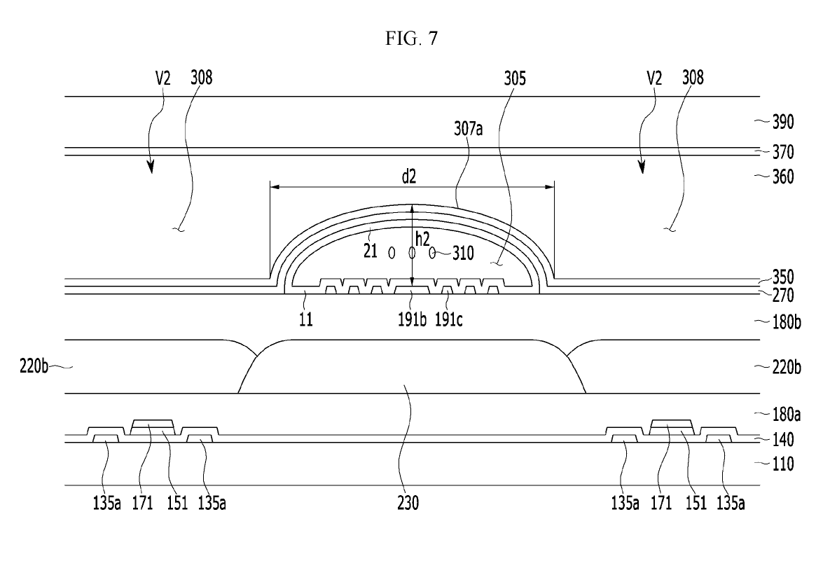

Next, the liquid crystal display according to an exemplary embodiment of the present disclosure will be described with reference to FIG. 4 and FIG. 7. The description for the same configurations as in the above-described exemplary embodiment is omitted, and differences are mainly described. FIG. 7 is a view showing one example of a cross-section taken along a line V-V of FIG. 3.

FIG. 4, taken along the line IV-IV of FIG. 3, shows the height h1 of the roof layer 360 near the microcavity center part and the distance d1 between the partitions 308, and FIG. 7, taken along the line V-V of FIG. 3, shows the height h2 of the roof layer 360 in the first inlet part 307a and the distance d2 between the partitions 308.

Comparing FIG. 4 and FIG. 7, for the distance between two partitions 308 facing each other via the microcavity 305 interposed therebetween, the distance d2 in the first inlet part 307a is shorter than the distance d1 in the center part of the microcavity 305.

When the distance from the bottom of the microcavity 305 to the position where the microcavity 305 extends vertically and firstly meets the roof layer 360 is referred to as the height of the roof layer 360, for the height of the roof layer 360, the second height h2 in the first inlet part 307a is lower than the first height h1 in the center part of the microcavity 305. The cross-sectional shape of the first inlet part 307a formed in the roof layer 360 may be a semi-elliptical shape.

Although not shown separately from the cross-sectional view, the distance between the partitions 308 in the first inlet part 307a and the second inlet part 307b, the height of the roof layer 360, and the cross-sectional shape of the inlet part 307a and 307b may be the same.

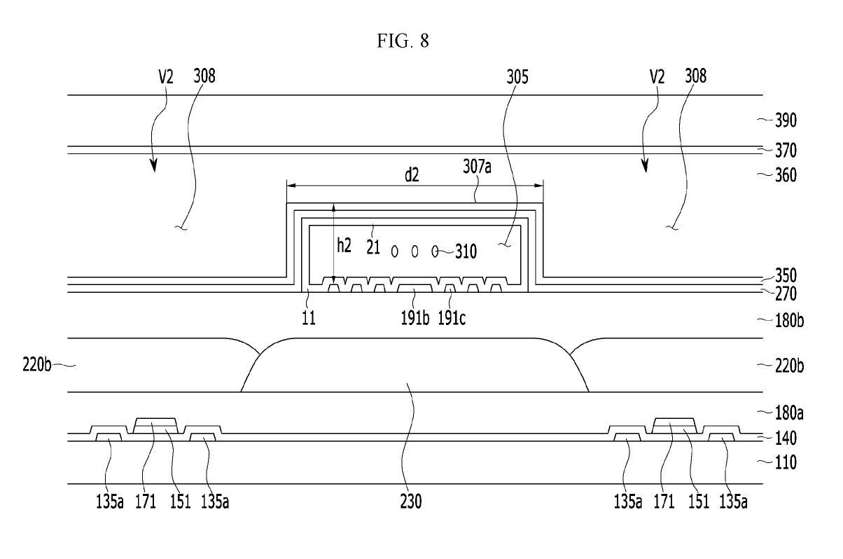

Next, the liquid crystal display according to an exemplary embodiment of the present disclosure will be described with reference to FIG. 4 and FIG. 8. The description for the same configurations as in the above-described exemplary embodiment is omitted and differences are mainly described. FIG. 8 is a view showing one example of a cross-section taken along a line V-V of FIG. 3.

FIG. 4 taken along the line IV-IV of FIG. 3 shows the height h1 of the roof layer 360 near the microcavity center part and the distance d1 between the partitions 308, and FIG. 8 taken along the line V-V of FIG. 3 shows the height h2 of the roof layer 360 in the first inlet part 307a and the distance d2 between the partitions 308.

Comparing FIG. 4 and FIG. 8, for the distance between two partitions 308 facing each other via the microcavity 305 interposed therebetween, the distance d2 in the first inlet part 307a is shorter than the distance d1 in the center part of the microcavity 305.

When the distance from the bottom of the microcavity 305 to the position where the microcavity 305 extends vertically and firstly meets the roof layer 360 is referred to as the height of the roof layer 360, the roof layer height h1 in the center part of the microcavity 305 and the roof layer height h2 in the first inlet part 307a may be the same.

Although not shown separately from the cross-sectional view, the distance between the partitions 308 in the first inlet part 307a and the second inlet part 307b, the height of the roof layer 360, and the cross-sectional shape of the inlet part 307a and 307b may be the same.

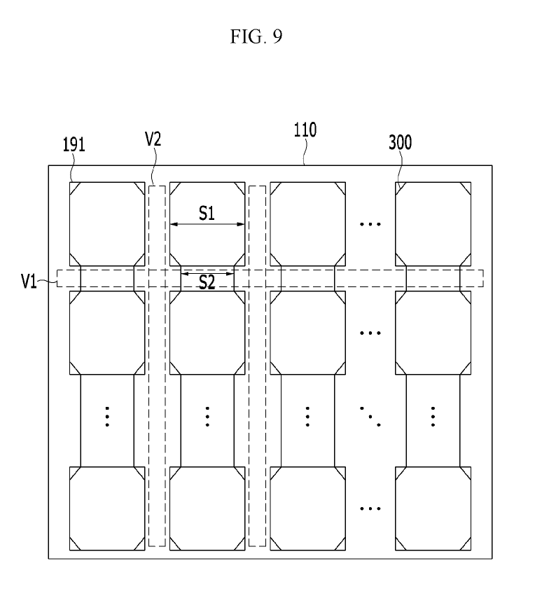

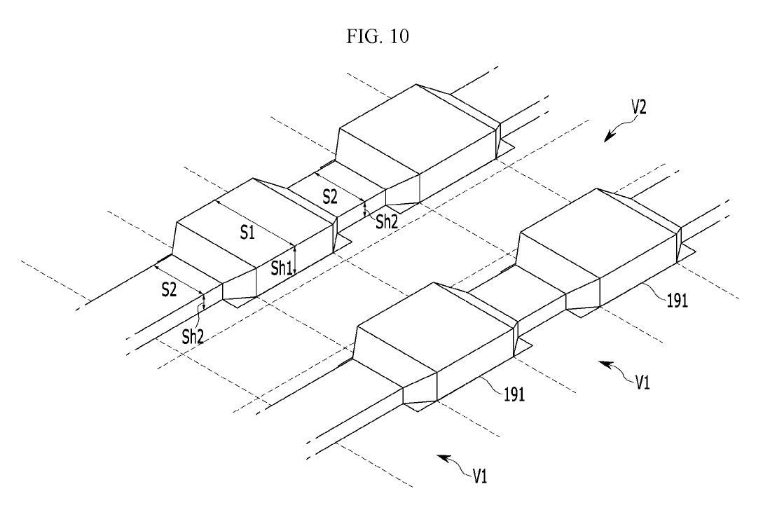

Next, a manufacturing method of the liquid crystal display according to an exemplary embodiment of the present disclosure will be described with reference to FIG. 3 to FIG. 6, FIG. 9, and FIG. 10. The exemplary embodiment described in the following is an exemplary embodiment of the manufacturing method, and thus may be modified in another form and thereby implemented.

FIG. 9 and FIG. 10 are views schematically showing a sacrificial layer in a manufacturing method of a liquid crystal display according to an exemplary embodiment of the present disclosure.

The gate line 121 and the storage electrode line 131 are formed on the substrate 110 including the first region V1 and the second region V2 vertical crossing to each other, the gate insulating layer 140 is formed on the gate line 121 and the storage electrode line 131, the semiconductor stripe layer 151 and the semiconductor layer 154 are formed on the gate insulating layer 140, and then the data line 171 and the drain electrode 175 are formed on the semiconductor stripe layer 151 and the semiconductor layer 154.

The gate line 121 may be formed along the first region V1, and the data line 171 may be formed along the second region V2.

The gate line 121 includes the gate electrode 124, and the data line 171 includes the source electrode 173. The drain electrode 175 is divided from the data line 171, is formed on the semiconductor layer 154, and faces the source electrode 173 with respect to the gate electrode 124.

The first interlayer insulating layer 180a is formed on the data line 171, the semiconductor layer 154, and the gate insulating layer 140, and the color filter 230, the transverse light blocking member 220a, and the longitudinal light blocking member 220b are formed on the first interlayer insulating layer 180a.

The transverse light blocking member 220a is formed along the first region

V1, the longitudinal light blocking member 220b is formed along the second region V2, and the transverse light blocking member 220a and the longitudinal light blocking member 220b are connected to each other, thereby forming a lattice structure having the opening. The color filter 230 is formed in the opening by the transverse light blocking member 220a and the longitudinal light blocking member 220b.

Also, after forming the second interlayer insulating layer 180b on the color filter 230, the transverse light blocking member 220a, and the longitudinal light blocking member 220b, the pixel electrode 191 connected to the drain electrode 175 through the contact hole 185 is formed on the second interlayer insulating layer 180b.

A plurality of sacrificial layers 300 covering the pixel electrode 191 and part of the first region V1 and divided by the second region V2 as a border are formed on the pixel electrode 191.

Referring to FIG. 9 and FIG. 10, for the sacrificial layer 300, the width S2 in the first region V1 is formed to be narrower than the width 51 in the center part of the pixel electrode 191. The width of the sacrificial layer 300 may be formed to be gradually decreased from the width 51 in the center part of the pixel electrode 191 to the width S2 in the first region V1. For the sacrificial layer 300, the height Sh2 in the first region V1 may be formed to be lower than the height Sh1 in the center part of the pixel electrode 191. The height of the sacrificial layer 300 may be formed to be gradually lower from the height Sh1 in the center part of the pixel electrode 191 to the height Sh2 in the first region V1. However, the shape of the sacrificial layer 300 is not limited to FIG. 9 and FIG. 10, and the cross-sectional shape may be the semi-oval shape.

The common electrode 270, the lower insulating layer 350, the roof layer 360, and the upper insulating layer 370 are sequentially formed on the sacrificial layer 300. The roof layer 360 forms the partition 308 while filling the second region V2.

The common electrode 270, the lower insulating layer 350, the roof layer 360, and the upper insulating layer 370 that are disposed in the first region V1 are removed through an exposure and developing process or an etching process.

The sacrificial layer 300 is removed by an ashing process using oxygen gas or a wet etching method. In this case, the microcavity 305 is formed, and the first inlet part 307a and the second inlet part 307b are formed in the roof layer 360. The microcavity 305 is the empty space formed when the sacrificial layer 300 is removed. The alignment material is injected into the microcavity 305 through the first inlet part 307a and the second inlet part 307b to be hardened, thereby forming the lower alignment layer 11 and the upper alignment layer 21.

The liquid crystal material including the liquid crystal molecules 310 is injected in the microcavity 305 through the first inlet part 307a and the second inlet part 307b by using an Inkjet method.

The capping layer 390 covering the first inlet part 307a and the second inlet part 307b is formed on the upper insulating layer 370.

While the inventive concept has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims.

<Description of symbols>

| | |
|---|---|
| 110: substrate | 121: gate line |
| 171: data line | 191: pixel electrode |
| 307a: first inlet part | 307b: second inlet part |
| 308: partition | 360: roof layer |

What is claimed is:

1. A liquid crystal display comprising:
a substrate;
a thin film transistor disposed on the substrate;
a pixel electrode connected to the thin film transistor;
a roof layer overlapping the pixel electrode; and
a liquid crystal layer disposed in a plurality of microcavities between the pixel electrode and the roof layer,
wherein the roof layer includes two partitions disposed at respective sides of a microcavity selected from the plurality of microcavities and facing each other and a first inlet part and a second inlet part facing each other in a direction crossing a direction in which the two partitions face each other,
a distance between the two partitions is shorter in the first inlet part than in a center part of the microcavity, and
the distance between the two partitions is shorter in the second inlet part than in the center part of the microcavity.

2. The liquid crystal display of claim 1, wherein
the distance between the two partitions is the same in the first inlet part and the second inlet part.

3. The liquid crystal display of claim 2, wherein
a height of the roof layer is lower in the first inlet part than in the center part of the microcavity.

4. The liquid crystal display of claim 3, wherein
the height of the roof layer is lower in the second inlet part than in the center part of the microcavity.

5. The liquid crystal display of claim 4, wherein
the height of the roof layer is the same in the first inlet part and the second inlet part.

6. The liquid crystal display of claim 5, wherein
a cross-sectional shape of the first inlet part and the second inlet part is a semi-elliptical shape.

7. The liquid crystal display of claim 2, wherein
the distance between the partitions is gradually decreased from the center part of the microcavity toward the first inlet part and the second inlet part.

8. The liquid crystal display of claim 2, wherein
the distance between the two partitions in the first inlet part and the second inlet part is 90% or less of the distance between the partitions in the center part of the microcavity.

9. The liquid crystal display of claim 5, wherein
the height of the roof layer is gradually decreased from the center part of the microcavity toward the first inlet part and the second inlet part.

10. The liquid crystal display of claim 5, wherein
the height of the roof layer in the first inlet part and the second inlet part is 90% or less of the height of the roof layer in the center part of the microcavity.

11. A method for a liquid crystal display comprising:
forming a thin film transistor on a substrate including a first region and a second region crossing perpendicularly to each other;
forming a pixel electrode on the thin film transistor;
forming a plurality of sacrificial layers covering the pixel electrode and the first region and divided by the second region as a border;
forming a roof layer on the plurality of sacrificial layers;
removing the plurality of sacrificial layers to form a microcavity and a first inlet part and a second inlet part in the roof layer;
forming an alignment layer at an inner wall of the microcavity;
injecting a liquid crystal material into the microcavity; and
forming a capping layer to cover the first inlet part and the second inlet part on the roof layer,
wherein a width of the sacrificial layer is narrower in the first region than in a center part of the pixel electrode.

12. The method of claim 11, wherein
the width of the sacrificial layer is gradually narrower from the center part of the pixel electrode toward the first region.

13. The method of claim 12, wherein
the sacrificial layer has a height gradually lower from the center part of the pixel electrode toward the first region.

14. The method of claim 13, wherein
the sacrificial layer has a cross-section of a semi-elliptical shape in the first region.
